(19) United States
(12) Patent Application Publication
(10) Pub. No.: US 2026/0326726 A1
(43) Pub. Date: Oct. 22, 2026

(54) CONTROLLER AND CONTROL METHOD

(71) Applicant: Robert Bosch GmbH, Stuttgart (DE)

(72) Inventor: Jun Ohtaka, Kanagawa (JP)

(21) Appl. No.: 19/110,472

(22) PCT Filed: Aug. 9, 2023
(86) PCT No.: PCT/IB2023/058028

§ 371 Date: Mar. 11, 2025

(30) Foreign Application Priority Data
Sep. 22, 2022 (JP) 2022-151533

(51) Int. Cl. B60T 7/12; B60T 8/17; B60T 8/26; B60T 8/58

(52) U.S. Cl. CPC B60T 7/12; B60T 8/1706; B60T 8/261; B60T 8/58; B60T 2210/20

(57) ABSTRACT

The invention obtains a controller and a control method capable of reducing time and effort to operate a straddle-type vehicle.

In a controller 20 and a control method according to the invention, an acquisition section of the controller 20 acquires drive source information that is information on a drive source (an engine 11) of a straddle-type vehicle 1. Furthermore, an execution section of the controller 20 executes drive wheel locking to lock a drive wheel (a rear wheel 3) of the straddle-type vehicle 1 by braking the drive wheel not on the basis of an operation by a rider of the straddle-type vehicle 1. The execution section initiates the drive wheel locking in the case where the drive source information is information indicating that the drive source is stopped.

### BACKGROUND

The present disclosure relates to a controller and a control method capable of reducing time and effort to operate a straddle-type vehicle.

As a conventional technique related to a straddle-type vehicle such as a motorcycle, a technique of assisting a rider has been available. For example, a driver-assistance system is disclosed in JP2009-116882A. The driver-assistance system warns the rider of the motorcycle that the motorcycle inappropriately approaches an obstacle on the basis of information detected by a sensor device that detects the obstacle present in a travel direction or substantially in the travel direction.

By the way, a parking brake is used to suppress movement of a vehicle while the vehicle is parked. A driver can actuate the parking brake by operating an operation section that works with the parking brake. Here, an operation at the time of parking tends to be more complicated for the straddle-type vehicle than for an automobile with four wheels due to need for the rider to support a vehicle body with his or her legs, and the like. The above operation related to the parking brake at the time of parking is a factor that increases the time and effort in the rider's operation. For this reason, it has been desired to assist the rider at the time of parking, so as to reduce the time and effort in the rider's operation.

The invention has been made with the above-described problem as the background and therefore obtains a controller and a control method capable of reducing time and effort to operate a straddle-type vehicle.

### SUMMARY

A controller according to the invention is a controller that controls a straddle-type vehicle. The controller includes an acquisition section that acquires drive source information as information on a drive source of the straddle-type vehicle, and further includes an execution section that executes drive wheel locking to lock a drive wheel of the straddle-type vehicle by braking the drive wheel not on the basis of an operation by a rider of the straddle-type vehicle. The execution section initiates the drive wheel locking in the case where the drive source information is information indicating that the drive source is stopped.

A control method according to the invention is a control method for controlling a straddle-type vehicle. The control method includes acquiring drive source information by an acquisition section of a controller, the drive source information being information on a drive source of the straddle-type vehicle. The control method further includes executing drive wheel locking by an execution section of the controller, in the drive wheel locking, a drive wheel of the straddle-type vehicle being braked and thereby locked not on the basis of an operation by a rider of the straddle-type vehicle. The execution section initiates the drive wheel locking in the case where the drive source information is information indicating that the drive source is stopped.

In the controller and the control method according to the invention, the acquisition section of the controller acquires the drive source information that is the information on the drive source of the straddle-type vehicle, and furthermore, the execution section of the controller executes the drive wheel locking to lock the drive wheel of the straddle-type vehicle by braking the drive wheel not on the basis of the operation by the rider of the straddle-type vehicle. The execution section initiates the drive wheel locking in the case where the drive source information is the information indicating that the drive source is stopped. In this way, when the rider parks the straddle-type vehicle, the drive wheel locking is initiated without relying on the rider's operation, and movement of a vehicle body can thereby be suppressed. Therefore, it is possible to reduce time and effort to operate the straddle-type vehicle.

### BRIEF DESCRIPTION OF THE DRAWINGS

FIG. 1 is a schematic view illustrating an outline configuration of a straddle-type vehicle according to an embodiment of the invention.

FIG. 2 is a schematic view illustrating an outline configuration of a brake system according to the embodiment of the invention.

FIG. 3 is a block diagram illustrating an example of a functional configuration of a controller according to the embodiment of the invention.

FIG. 4 is a flowchart illustrating an example of a processing procedure that is executed by the controller according to the embodiment of the invention.

### DETAILED DESCRIPTION

A description will hereinafter be made on a controller and a control method according to the invention with reference to the drawings.

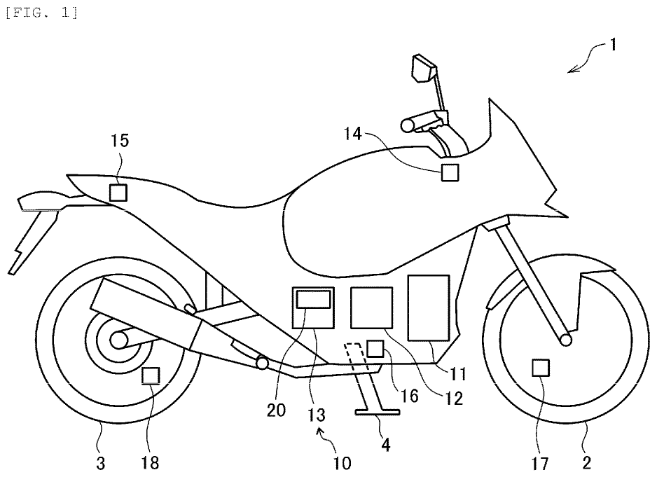

Hereinafter, a description will be made on a controller that is used for a two-wheeled motorcycle (see a straddle-type vehicle 1 in FIG. 1). However, a vehicle as a control target of the controller according to the invention may be a straddle-type vehicle other than the two-wheeled motorcycle. The straddle-type vehicle means a vehicle that a rider straddles. Examples of the straddle-type vehicle are motorcycles (a two-wheeled motor vehicle and a three-wheeled motor vehicle), an all-terrain vehicle, a snowmobile, and a bicycle. The motorcycles include a vehicle having an engine as a power source, a vehicle having an electric motor as the power source, and the like. Examples of the motorcycles are a motorbike, a scooter, and an electric scooter. The bicycle means a vehicle capable of traveling forward on a road by a depression force applied to pedals by the rider. Examples of the bicycle are a normal bicycle, an electrically-assisted bicycle, and an electric bicycle.

Hereinafter, a description will be made on a case where the engine (more specifically, an engine 11 in FIG. 1, which will be described below) is mounted as a drive source capable of outputting power for driving a drive wheel (more specifically, a rear wheel 3 in FIG. 1). However, as the drive source, a drive source other than the engine (for example, the electric motor) may be mounted, or plural types of the drive sources may be mounted.

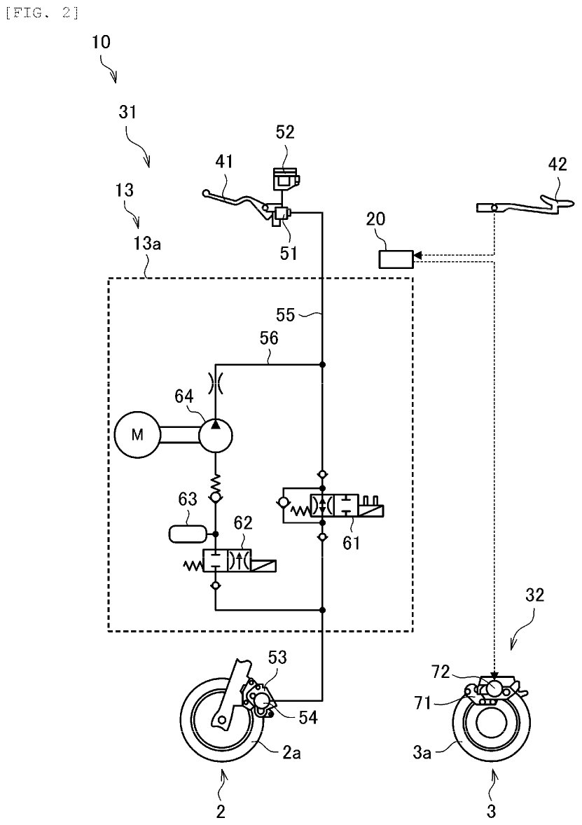

Hereinafter, a description will be made on a case where, as a mechanism that brakes the drive wheel (more specifically, the rear wheel 3 in FIG. 1), a mechanism that brakes the drive wheel by using electric power (more specifically, a rear-wheel brake mechanism 32 in FIG. 2, which will be described below) is adopted. However, as the mechanism that brakes the drive wheel, a mechanism that brakes the drive wheel by using a brake fluid may be adopted. As the mechanism that brakes the drive wheel, a mechanism may be adopted that brakes the drive wheel by using the electric power at the time when drive wheel locking, which will be described below, is executed and that brakes the drive wheel by using the brake fluid at the time when the drive wheel locking is not executed.

A configuration, operation, and the like, which will be described below, merely constitute one example. The controller and the control method according to the invention are not limited to a case with such a configuration, such operation, and the like.

The same or similar description will appropriately be simplified or will not be made below. In the drawings, the same or similar members or portions will not be denoted by a reference sign or will be denoted by the same reference sign. A detailed structure will appropriately be illustrated in a simplified manner or will not be illustrated.

### Configuration of Straddle-Type Vehicle

A description will be made on a configuration of the straddle-type vehicle 1 according to the embodiment of the invention with reference to FIG. 1 to FIG. 3.

FIG. 1 is a schematic view illustrating an outline configuration of the straddle-type vehicle 1. The straddle-type vehicle 1 is a two-wheeled motorcycle that corresponds to an example of the straddle-type vehicle according to the invention. As illustrated in FIG. 1, the straddle-type vehicle 1 includes a front wheel 2, the rear wheel 3, a kickstand 4, the engine 11, a gear shift mechanism 12, a hydraulic pressure control unit 13, an ignition switch 14, an inertial measurement unit (IMU) 15, a kickstand sensor 16, a front-wheel rotational frequency sensor 17, a rear-wheel rotational frequency sensor 18, and a controller (ECU) 20.

The engine 11 corresponds to an example of a drive source of the straddle-type vehicle 1, and can output power for driving the rear wheel 3 as the drive wheel. For example, the engine 11 is provided with: one or plural cylinders, each of which is formed with a combustion chamber therein; a fuel injector that injects fuel into the combustion chamber; and an ignition plug. When the fuel is injected from the fuel injector, air-fuel mixture containing air and the fuel is produced in the combustion chamber, and the air-fuel mixture is then ignited by the ignition plug and burned. Consequently, a piston provided in the cylinder reciprocates to cause a crankshaft to rotate. In addition, a throttle valve is provided to an intake pipe of the engine 11, and an intake air amount to the combustion chamber varies according to a throttle opening amount as an opening amount of the throttle valve.

The gear shift mechanism 12 is an automatic gear shift mechanism and can change a gear ratio without relying on a rider's operation. In other words, the straddle-type vehicle 1 is an automatic vehicle. An input shaft of the gear shift mechanism 12 is connected to the crankshaft of the engine 11. An output shaft of the gear shift mechanism 12 is connected to the rear wheel 3 as the drive wheel. Thus, the power that is output from the engine 11 is first transmitted to the gear shift mechanism 12, an amount thereof is changed by the gear shift mechanism 12, and the power is then transmitted to the rear wheel 3. The gear shift mechanism 12 is a gear shift mechanism that cannot lock the rear wheel 3 as the drive wheel when the engine 11 is stopped.

The hydraulic pressure control unit 13 is a unit that has a function of controlling a braking force generated on the wheel. For example, the hydraulic pressure control unit 13 includes components (for example, a control valve and a pump) that are provided to an oil channel connecting a master cylinder and a wheel cylinder and control a brake hydraulic pressure in the wheel cylinder. The braking force generated on the wheel is controlled by controlling operation of the components of the hydraulic pressure control unit 13.

A detailed description on a brake system 10 that includes the hydraulic pressure control unit 13 will be made below. The hydraulic pressure control unit 13 includes the controller 20, and operation of the brake system 10 is controlled by the controller 20. A detailed description on the controller 20 will be made below.

The ignition switch 14 is a switch to start the engine 11. The rider can start or stop the engine 11 by performing an operation using the ignition switch 14. In addition, the ignition switch 14 outputs, to the controller 20, drive source information that is information on the drive source (the engine 11 in the example illustrated in FIG. 1). An example of the drive source information is information indicating ignition ON. The ignition ON means a state where the engine 11 is activated. Another example of the drive source information is information indicating ignition OFF. The ignition OFF means a state where the engine 11 is stopped.

The IMU 15 includes a three-axis gyroscope sensor and a three-directional acceleration sensor, and detects a posture of the straddle-type vehicle 1. The IMU 15 is provided to a trunk of the straddle-type vehicle 1, for example. For example, the IMU 15 detects a pitch angle of the straddle-type vehicle 1 and outputs a detection result. The IMU 15 may detect another physical quantity that can substantially be converted to the pitch angle of the straddle-type vehicle 1. The pitch angle corresponds to an angle representing a tilt in a longitudinal direction of a vehicle body (more specifically, the trunk) of the straddle-type vehicle 1 with respect to a horizontal direction. In other words, the pitch angle corresponds to an angle that represents how much the vehicle body of the straddle-type vehicle 1 rotates from the posture facing the horizontal direction in a pitch direction as a rotational direction with an axis in a vehicle right-left direction being a center. The IMU 15 may only include parts of the three-axis gyroscope sensor and the three-directional acceleration sensor.

The kickstand sensor 16 detects information on the kickstand 4. The kickstand 4 is provided to support the vehicle body of the straddle-type vehicle 1 during parking of the straddle-type vehicle 1. When the straddle-type vehicle 1 travels, the kickstand 4 is in a state of being retracted to a vehicle body side (hereinafter, also referred to as a retracted state). Meanwhile, when the straddle-type vehicle 1 is parked, the kickstand 4 is in a state of being projected to a ground side and capable of supporting the vehicle body (hereinafter also referred to as a projected state). For example, the kickstand sensor 16 detects, as the information on the kickstand 4, information indicating whether the kickstand 4 is in the retracted state or the projected state.

The front-wheel rotational frequency sensor 17 is a wheel rotational frequency sensor that detects a rotational frequency of the front wheel 2 (for example, a rotational frequency of the front wheel 2 per unit time [rpm], a travel distance of the front wheel 2 per unit time [km/h], or the like), and outputs a detection result. The front-wheel rotational frequency sensor 17 may detect another physical quantity that can substantially be converted to the rotational frequency of the front wheel 2. The front-wheel rotational frequency sensor 17 is provided to the front wheel 2.

The rear-wheel rotational frequency sensor 18 is a wheel rotational frequency sensor that detects a rotational frequency of the rear wheel 3 (for example, the rotational frequency of the rear wheel 3 per unit time [rpm], a travel distance of the rear wheel 3 per unit time [km/h], or the like), and outputs a detection result. The rear-wheel rotational frequency sensor 18 may detect another physical quantity that can substantially be converted to the rotational frequency of the rear wheel 3. The rear-wheel rotational frequency sensor 18 is provided to the rear wheel 3.

A description will herein be made on an outline configuration of the brake system 10 for the straddle-type vehicle 1 and control of the braking force generated to the straddle-type vehicle 1 with reference to FIG. 2. FIG. 2 is a schematic view illustrating the outline configuration of the brake system 10. As illustrated in FIG. 2, the brake system 10 has a front-wheel brake mechanism 31, the rear-wheel brake mechanism 32, a first brake operation section 41, and a second brake operation section 42. The first brake operation section 41 is a brake lever, for example. The front-wheel brake mechanism 31 brakes the front wheel 2 in an interlocking manner with at least the first brake operation section 41. The second brake operation section 42 is a brake pedal, for example. The rear-wheel brake mechanism 32 brakes the rear wheel 3 in an interlocking manner with at least the second brake operation section 42. The front-wheel brake mechanism 31 is partially included in the hydraulic pressure control unit 13.

The front-wheel brake mechanism 31 includes: a master cylinder 51 that includes a piston (not illustrated); a reservoir 52 that is attached to the master cylinder 51; a brake caliper 53 that is held by the trunk of the straddle-type vehicle 1 and has a brake pad (not illustrated); a wheel cylinder 54 that is provided to the brake caliper 53; a primary channel 55 through which a brake fluid in the master cylinder 51 flows into the wheel cylinder 54; and a secondary channel 56 through which the brake fluid in the wheel cylinder 54 is released.

An inlet valve (EV) 61 is provided to the primary channel 55. The secondary channel 56 bypasses a portion of the primary channel 55 between a wheel cylinder 54 side and a master cylinder 51 side of the inlet valve 61. The secondary channel 56 is sequentially provided with an outlet valve (AV) 62, an accumulator 63, and a pump 64 from an upstream side.

The inlet valve 61 is an electromagnetic valve that is opened in an unenergized state and is closed in an energized state, for example. The outlet valve 62 is an electromagnetic valve that is closed in an unenergized state and is opened in an energized state, for example.

The hydraulic pressure control unit 13 includes: components, such as the inlet valve 61, the outlet valve 62, the accumulator 63, and the pump 64, that are used to control the brake hydraulic pressure; and a base body 13a in which those components are provided and channels constituting the primary channel 55 and the secondary channel 56 are formed.

The base body 13a may be formed of one member or may be formed of plural members. In addition, in the case where the base body 13a is formed of the plural members, the components may separately be provided to the different members.

The controller 20 controls operation of the above components of the hydraulic pressure control unit 13. Consequently, the front-wheel brake mechanism 31 controls the braking force generated on the front wheel 2.

During a normal time (that is, when the braking force corresponding to a brake operation by the rider is set to be generated on the wheel), the controller 20 opens the inlet valve 61 and closes the outlet valve 62. When the first brake operation section 41 is operated in such a state, in the front-wheel brake mechanism 31, the piston (not illustrated) in the master cylinder 51 is pressed to increase the hydraulic pressure of the brake fluid in the wheel cylinder 54, the brake pad (not illustrated) of the brake caliper 53 is then pressed against a rotor 2a of the front wheel 2, and the braking force is thereby generated on the front wheel 2.

The rear-wheel brake mechanism 32 is held by the trunk of the straddle-type vehicle 1 and includes: a brake caliper 71 that has a brake pad (not illustrated); and an actuator 72 provided to the brake caliper 71. The actuator 72 is a device that is driven by using the electric power, and is a motor, for example. When the actuator 72 is driven, a brake pad (not illustrated) of the brake caliper 71 is pressed against a rotor 3a of the rear wheel 3.

An operation amount of the second brake operation section 42 is output to the controller 20. The controller 20 controls the actuator 72 such that a pressing force corresponding to the operation amount of the second brake operation section 42 is applied to the rotor 3a of the rear wheel 3 by the brake pad (not illustrated) of the brake caliper 71. As a result, the braking force generated on the rear wheel 3 is controlled by the rear-wheel brake mechanism 32.

During the normal time (that is, when the braking force corresponding to the brake operation by the rider is set to be generated on the wheel), when the second brake operation section 42 is operated, the controller 20 drives the actuator 72. Then, in the rear-wheel brake mechanism 32, the brake pad (not illustrated) of the brake caliper 71 is pressed against the rotor 3a of the rear wheel 3, and the braking force is thereby generated on the rear wheel 3.

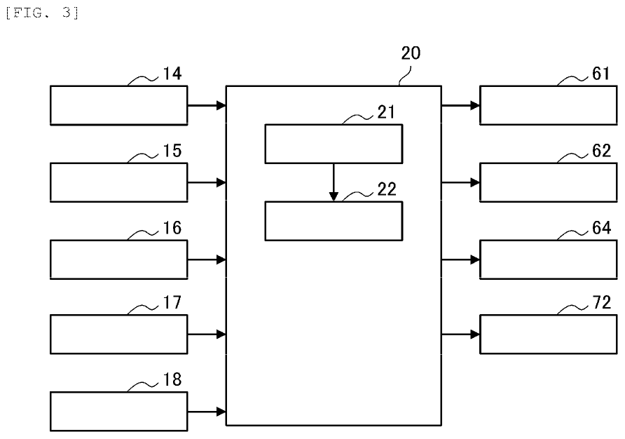

FIG. 3 is a block diagram illustrating an example of a functional configuration of the controller 20. The controller 20 controls the straddle-type vehicle 1. For example, a microcomputer, a microprocessor unit, or the like constitutes a part or whole of the controller 20. Alternatively, the part or the whole of the controller 20 may be one whose firmware and the like can be updated, or may be a program module or the like that is executed by a command from a CPU or the like, for example. The controller 20 may be provided as one unit or may be divided into plural units, for example.

As illustrated in FIG. 3, the controller 20 includes an acquisition section 21 and an execution section 22, for example. In addition, the controller 20 communicates with each of the devices in the straddle-type vehicle 1.

The acquisition section 21 acquires information from each of the devices in the straddle-type vehicle 1, and outputs the acquired information to the execution section 22. For example, the acquisition section 21 acquires the information from the ignition switch 14, the IMU 15, the kickstand sensor 16, the front-wheel rotational frequency sensor 17, and the rear-wheel rotational frequency sensor 18. In the present specification, the acquisition of the information can include extraction, generation, and the like of the information.

The execution section 22 executes various types of control by controlling operation of each of the devices in the straddle-type vehicle 1. For example, the execution section 22 controls operation of the inlet valve 61, the outlet valve 62, the pump 64, and the actuator 72. In particular, the execution section 22 executes drive wheel locking. The drive wheel locking is control to lock the drive wheel (more specifically, the rear wheel 3) of the straddle-type vehicle 1 by braking the drive wheel not on the basis of the operation by the rider of the straddle-type vehicle 1.

The execution section 22 executes the drive wheel locking in a situation where the second brake operation section 42 is not operated. In the drive wheel locking, the execution section 22 drives the actuator 72 of the rear-wheel brake mechanism 32. Consequently, the rear wheel 3 as the drive wheel is braked and thereby locked not on the basis of the rider's operation. Thus, it is possible to suppress movement of the straddle-type vehicle 1 (for example, sliding down of the straddle-type vehicle 1 on a sloping road or the like due to an influence of weight, the movement of the straddle-type vehicle 1 during parking, or the like).

### Operation of Controller

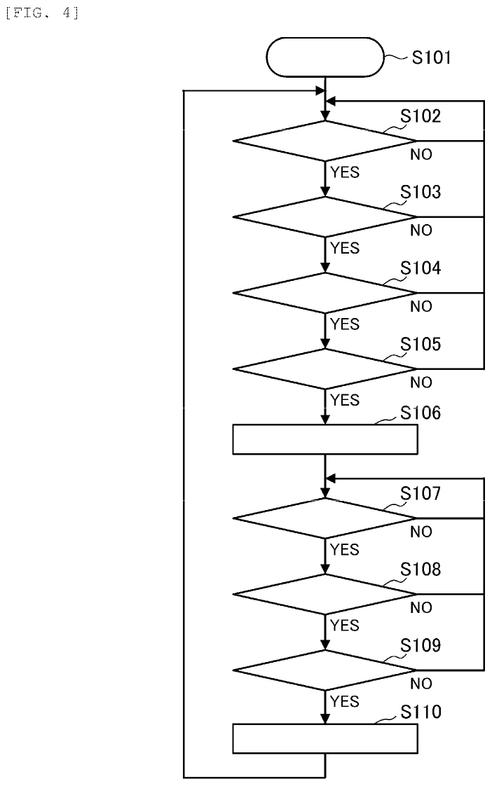

A description will be made on operation of the controller 20 according to the embodiment of the invention with reference to FIG. 4.

As described above, the execution section 22 of the controller 20 can execute the drive wheel locking. Here, the execution section 22 initiates the drive wheel locking in the case where the drive source information is information indicating that the drive source (the engine 11 in the above example) is stopped. In this way, as will be described below, time and effort to operate the straddle-type vehicle 1 is reduced.

FIG. 4 is a flowchart illustrating an example of an overall processing procedure that is executed by the controller 20. Step S101 in FIG. 4 corresponds to initiation of a control flow illustrated in FIG. 4. When the control flow illustrated in FIG. 4 is initiated, it is in a state where the drive wheel locking is not executed.

When the control flow illustrated in FIG. 4 is initiated, in step S102, the execution section 22 determines whether the ignition of the engine 11 is OFF. The execution section 22 makes the determination in step S102, for example, on the basis of the drive source information that is acquired from the ignition switch 14. A case where it is determined that the ignition of the engine 11 is OFF corresponds to a case where the drive source information is the information indicating that the engine 11 is stopped.

If it is determined that the ignition of the engine 11 is ON (step S102/NO), the processing in step S102 is repeated. On the other hand, if it is determined that the ignition of the engine 11 is OFF (step S102/YES), the processing proceeds to step S103.

If it is determined YES in step S102, in step S103, the execution section 22 determines whether a vehicle speed (that is, a speed of the vehicle body) of the straddle-type vehicle 1 is lower than a reference vehicle speed. The vehicle speed of the straddle-type vehicle 1 can be acquired on the basis of the detection result of the front-wheel rotational frequency sensor 17 and the detection result of the rear-wheel rotational frequency sensor 18, for example. The reference vehicle speed is set to a value near zero, for example. The case where the vehicle speed of the straddle-type vehicle 1 is lower than the reference vehicle speed corresponds to a case where the straddle-type vehicle 1 is stopped.

If it is determined that the vehicle speed of the straddle-type vehicle 1 is equal to or higher than the reference vehicle speed (step S103/NO), the processing returns to step S102. On the other hand, if it is determined that the vehicle speed of the straddle-type vehicle 1 is lower than the reference vehicle speed (step S103/YES), the processing proceeds to step S104.

If it is determined YES in step S103, in step S104, the execution section 22 determines whether the kickstand 4 is in the projected state. The execution section 22 makes the determination in step S104, for example, on the basis of the information on the kickstand 4 that is acquired from the kickstand sensor 16.

If it is determined that the kickstand 4 is in the retracted state (step S104/NO), the processing returns to step S102. On the other hand, if it is determined that the kickstand 4 is in the projected state (step S104/YES), the processing proceeds to step S105.

If it is determined YES in step S104, in step S105, the execution section 22 determines whether an absolute value of a gradient of a road surface is larger than a reference value. For example, a value of the gradient of the road surface can be acquired on the basis of the pitch angle of the straddle-type vehicle 1 that is acquired by the IMU 15. The reference value is set to a value near zero, for example. A case where the absolute value of the gradient of the road surface is larger than the reference value corresponds to a case where the straddle-type vehicle 1 is stopped on the sloping road. A case where the absolute value of the gradient of the road surface is equal to or smaller than the reference value corresponds to a case where the straddle-type vehicle 1 is stopped on a flat road.

If it is determined that the absolute value of the gradient of the road surface is equal to or smaller than the reference value (step S105/NO), the processing returns to step S102. On the other hand, if it is determined that the absolute value of the gradient of the road surface is larger than the reference value (step S105/YES), the processing proceeds to step S106.

If it is determined YES in step S105, in step S106, the execution section 22 initiates the drive wheel locking. As described above, in the drive wheel locking, the execution section 22 drives the actuator 72 of the rear-wheel brake mechanism 32, brakes the rear wheel 3 as the drive wheel, and thereby locks the rear wheel 3.

The braking force that is generated on the rear wheel 3 in the drive wheel locking is set in advance to the braking force that is large enough to suppress sliding down of the straddle-type vehicle 1, for example. However, from a perspective of appropriately suppressing sliding down of the straddle-type vehicle 1, the execution section 22 preferably varies the braking force generated on the rear wheel 3 in the drive wheel locking on the basis of information on the gradient of the road surface. For example, in the case where the absolute value of the gradient of the road surface is large, the execution section 22 increases the braking force generated on the rear wheel 3 in the drive wheel locking to be larger than that in the case where the absolute value of the gradient of the road surface is small.

Next to step S106, in step S107, the execution section 22 determines whether the brake operation by the rider of the straddle-type vehicle 1 is performed. The execution section 22 makes the determination in step S107, for example, on the basis of a detection result of a sensor that detects the operation amount of the brake operation section in the brake system 10. For example, in the case where the brake operation is performed by using at least one of the first brake operation section 41 and the second brake operation section 42, it is determined YES in step S107.

If it is determined that the brake operation by the rider of the straddle-type vehicle 1 is not performed (step S107/NO), the processing in step S107 is repeated. On the other hand, if it is determined that the brake operation by the rider of the straddle-type vehicle 1 is performed (step S107/YES), the processing proceeds to step S108.

If it is determined YES in step S107, in step S108, the execution section 22 determines whether the ignition of the engine 11 is ON. The execution section 22 makes the determination in step S108, for example, on the basis of the drive source information that is acquired from the ignition switch 14.

If it is determined that the ignition of the engine 11 is OFF (step S108/NO), the processing returns to step S107. On the other hand, if it is determined that the ignition of the engine 11 is ON (step S108/YES), the processing proceeds to step S109.

If it is determined YES in step S108, in step S109, the execution section 22 determines whether the kickstand 4 is in the retracted state. The execution section 22 makes the determination in step S109, for example, on the basis of the information on the kickstand 4 that is acquired from the kickstand sensor 16.

If it is determined that the kickstand 4 is in the projected state (step S109/NO), the processing returns to step S107. On the other hand, if it is determined that the kickstand 4 is in the retracted state (step S109/YES), the processing proceeds to step S110.

If it is determined YES in step S109, in step S110, the execution section 22 cancels the drive wheel locking, and the processing returns to step S102. When the drive wheel locking is canceled, braking of the rear wheel 3 by the actuator 72 of the rear-wheel brake mechanism 32 is terminated, and the straddle-type vehicle 1 is brought into a state capable of starting.

As it has been described so far, the execution section 22 of the controller 20 initiates the drive wheel locking in the case where the drive source information is the information indicating that the drive source (the engine 11 in the above example) is stopped. Consequently, in a situation where the straddle-type vehicle 1 is parked or is about to be parked, the movement of the straddle-type vehicle 1 can be suppressed by the drive wheel locking without relying on the rider's operation. Thus, the time and effort in the operation to suppress the movement of the straddle-type vehicle 1 is reduced at the time of parking. In this way, the time and effort to operate the straddle-type vehicle 1 can be reduced.

The above description has been made on the example of the processing that is executed by the controller 20 with reference to the flowchart in FIG. 4. However, the processing executed by the controller 20 is not limited to the above example, and the processing may appropriately be, for example, added to, changed in, or deleted from the control flow illustrated in FIG. 4.

For example, in the control flow illustrated in FIG. 4, as the determination processing related to the initiation of the drive wheel locking, four types of the determination processing in steps S102, S103, S104, and S105 are executed. However, as the determination processing related to the initiation of the drive wheel locking, at least the processing in step S102 only needs to be executed. More specifically, some or all of the processing in steps S103, S104, and S105 may not be executed in the control flow illustrated in FIG. 4. In the case where the straddle-type vehicle 1 does not include the kickstand 4 (for example, in the case where the straddle-type vehicle 1 is the snowmobile, or the like), step S104 is omitted. In addition, as in the control flow illustrated in FIG. 4, by executing both types of the determination processing in steps S102 and S103 as the determination processing related to the initiation of the drive wheel locking, it is possible to suppress unnecessary execution of the drive wheel locking, for example, when the straddle-type vehicle 1 is temporarily stopped at a traffic signal.

In the control flow illustrated in FIG. 4, three types of the determination processing in steps S107, S108, and S109 are executed as the determination processing related to cancellation of the drive wheel locking. However, any of the processing in steps S107, S108, and S109 may be omitted from the control flow illustrated in FIG. 4. For example, the processing in only one of step S107 and step S108 may be executed. In the case where the straddle-type vehicle 1 does not include the kickstand 4 (for example, in the case where the straddle-type vehicle 1 is the snowmobile, or the like), step S109 is omitted. Alternatively, the execution section 22 may cancel the drive wheel locking with a particular operation performed by the rider as a trigger.

### Effects of Controller

A description will be made on effects of the controller 20 according to the embodiment of the invention.

The controller 20 includes the acquisition section 21 that acquires the drive source information as the information on the drive source (the engine 11 in the above example) of the straddle-type vehicle 1, and further includes the execution section 22 that executes the drive wheel locking to lock the drive wheel (more specifically, the rear wheel 3) of the straddle-type vehicle 1 by braking the drive wheel not on the basis of the operation by the rider of the straddle-type vehicle 1. Then, the execution section 22 initiates the drive wheel locking in the case where the drive source information is the information indicating that the drive source is stopped. In this way, in the situation where the straddle-type vehicle 1 is parked or is about to be parked, the movement of the straddle-type vehicle 1 can be suppressed by the drive wheel locking without relying on the rider's operation. Thus, the time and effort in the operation to suppress the movement of the straddle-type vehicle 1 is reduced at the time of parking. In this way, the time and effort to operate the straddle-type vehicle 1 can be reduced.

Preferably, in the controller 20, the execution section 22 initiates the drive wheel locking on the basis of, in addition to the drive source information, information on the vehicle speed of the straddle-type vehicle 1. In this way, the drive wheel locking can be initiated after the stop of the straddle-type vehicle 1 is checked. Thus, in the situation where the straddle-type vehicle 1 is parked or is about to be parked, the drive wheel locking is further appropriately initiated.

The information on the vehicle speed of the straddle-type vehicle 1 is the information indicating the vehicle speed of the straddle-type vehicle 1 in the above example. However, the information on the vehicle speed of the straddle-type vehicle 1 is not limited to that in the above example and can include various types of information. For example, the information on the vehicle speed of the straddle-type vehicle 1 may be information that can substantially be converted to the vehicle speed of the straddle-type vehicle 1.

Preferably, in the controller 20, the execution section 22 initiates the drive wheel locking on the basis of, in addition to the drive source information, the information on the kickstand 4 of the straddle-type vehicle 1. In this way, the drive wheel locking can be initiated after the projected state of the kickstand 4 is checked. Thus, in the situation where the straddle-type vehicle 1 is parked or is about to be parked, the drive wheel locking is further appropriately initiated.

The information on the kickstand 4 is the information indicating whether the kickstand 4 is in the retracted state or the projected state in the above example. However, the information on the kickstand 4 is not limited to the above example and can include various types of information. For example, the information on the kickstand 4 may be information that can substantially be converted to the information indicating whether the kickstand 4 is in the retracted state or the projected state.

Preferably, in the controller 20, the execution section 22 initiates the drive wheel locking on the basis of, in addition to the drive source information, information on the gradient of the road surface. In this way, the drive wheel locking can be initiated after the stop of the straddle-type vehicle 1 on the sloping road is checked. Thus, it is possible to suppress the unnecessary execution of the drive wheel locking when the straddle-type vehicle 1 is stopped on the flat road. However, the execution section 22 may initiate the drive wheel locking not on the basis of the information on the gradient of the road surface. For example, the processing in step S105 may be omitted from the flowchart in FIG. 4 that has been described above. In such a case, the drive wheel locking can be initiated also when the straddle-type vehicle 1 is parked at a location other than the sloping road.

The information on the gradient of the road surface is the information indicating the value of the gradient of the road surface in the above example. However, the information on the gradient of the road surface is not limited to that in the above example and can include various types of information. For example, the information on the gradient of the road surface may be information that can substantially be converted to the value of the gradient of the road surface.

Preferably, in the controller 20, the execution section 22 varies the braking force generated on the drive wheel in the drive wheel locking on the basis of the information on the gradient of the road surface. In this way, it is possible to appropriately adjust the braking force generated on the drive wheel in the drive wheel locking according to the absolute value of the gradient of the road surface. Thus, it is possible to appropriately suppress sliding down of the straddle-type vehicle 1. In addition, since it is possible to suppress the braking force generated on the drive wheel from being excessively increased in the drive wheel locking, the straddle-type vehicle 1 can easily be moved by hands of a person even during the execution of the drive wheel locking.

Preferably, in the controller 20, the execution section 22 cancels the drive wheel locking on the basis of the drive source information. In this way, the drive wheel locking can be canceled in a situation where drive power is generated to the straddle-type vehicle 1. Thus, it is possible to suppress the movement of the straddle-type vehicle 1, which is caused by the cancellation of the drive wheel locking.

Preferably, in the controller 20, the execution section 22 cancels the drive wheel locking on the basis of the information on the brake operation by the rider of the straddle-type vehicle 1. In this way, the drive wheel locking can be canceled in the situation where the braking force corresponding to the brake operation by the rider is generated to the straddle-type vehicle 1. Thus, it is possible to suppress the movement of the straddle-type vehicle 1, which is caused by the cancellation of the drive wheel locking.

The information on the brake operation is the information indicating the operation amount of the brake operation section in the above example. However, the information on the brake operation is not limited to that in the above example and can include various types of information. For example, the information on the brake operation may be information that can substantially be converted to the operation amount of the brake operation section.

Preferably, in the controller 20, the execution section 22 cancels the drive wheel locking on the basis of the information on the kickstand 4 of the straddle-type vehicle 1. In this way, the drive wheel locking can be canceled after the retracted state of the kickstand 4 and the rider's intention to start are checked. Thus, it is possible to suppress the movement of the straddle-type vehicle 1, which is caused by the cancellation of the drive wheel locking.

Preferably, in the controller 20, the drive source information includes information on the switch to start the drive source (the ignition switch 14 in the above example). In this way, the drive wheel locking can be executed after it is appropriately determined whether the drive source information is the information indicating that the drive source is stopped or the information indicating that the drive source is activated. Thus, in the situation where the straddle-type vehicle 1 is parked or is about to be parked, the drive wheel locking is further appropriately initiated.

The drive source information is not limited to the information on the switch to start the drive source and can include various types of information. For example, the drive source information may not be the information that is output from the switch to start the drive source, but may be the information output from the controller for controlling the drive source. For example, in the above example, the controller 20 may acquire, from a controller for controlling the engine 11, information indicating whether the engine 11 is in a stopped state or in an activated state for use. In addition, for example, the drive source information can include information on an operation amount of an accelerator operation (for example, an accelerator pedal position), information on output of the drive source (for example, output torque of the engine 11), or the like. Then, the execution section 22 may cancel the drive wheel locking on the basis of at least one of the information on the operation amount of the accelerator operation and the information on the output of the drive source. For example, the execution section 22 may cancel the drive wheel locking in the case where it is determined that a sufficient amount of the drive power is generated to the straddle-type vehicle 1 at least on the basis of the accelerator pedal position and the output torque of the engine 11. In this way, it is possible to further appropriately suppress the movement and sliding down of the straddle-type vehicle 1 on the sloping road or the like, which is caused by the cancellation of the drive wheel locking.

Preferably, in regard to the controller 20, the straddle-type vehicle 1 includes the gear shift mechanism 12 that cannot lock the drive wheel when the drive source is stopped. In other words, preferably, the straddle-type vehicle 1 is the automatic vehicle. In regard to a manual vehicle, when the drive source is stopped, a gear stage of the gear shift mechanism is set to a gear stage at which the drive wheel is locked by the gear shift mechanism. In this way, sliding down of the straddle-type vehicle 1 is suppressed. Meanwhile, in regard to the automatic vehicle, when the drive source is stopped, the drive wheel cannot be locked by the gear shift mechanism 12. Thus, locking of the drive wheel by the drive wheel locking is particularly effective. However, the straddle-type vehicle 1 is not limited to the automatic vehicle and may be the manual vehicle. For example, in the case where the straddle-type vehicle 1 is the manual vehicle, the drive wheel locking may be executed with a fact that the gear stage of the gear shift mechanism is not set to the gear stage, at which the drive wheel is locked by the gear shift mechanism, at the time of parking being the trigger.

The invention is not limited to the embodiment that has been described. For example, only a part of the embodiment may be implemented.

### REFERENCE SIGNS LIST

1: Straddle-type vehicle
2: Front wheel
2a: Rotor
3: Rear wheel
3a: Rotor
4: Kickstand
10: Brake system
11: Engine
12: Gear shift mechanism
13: Hydraulic pressure control unit
13a: Base body
14: Ignition switch
15: IMU
16: Kickstand sensor
17: Front-wheel rotational frequency sensor
18: Rear-wheel rotational frequency sensor
20: Controller
21: Acquisition section
22: Execution section
31: Front-wheel brake mechanism
32: Rear-wheel brake mechanism
41: First brake operation section
42: Second brake operation section
51: Master cylinder
52: Reservoir
53: Brake caliper
54: Wheel cylinder
55: Primary channel
56: Secondary channel
61: Inlet valve
62: Outlet valve
63: Accumulator
64: Pump
71: Brake caliper
72: Actuator

1. A controller (20) that controls a straddle-type vehicle (1), the controller comprising:
a computer configured to
acquire drive source information as information on a drive source (11) of the straddle-type vehicle (1), and
execute drive wheel locking to lock a drive wheel (3) of the straddle-type vehicle (1) by braking the drive wheel (3) not on the basis of an operation by a rider of the straddle-type vehicle (1), wherein
the computer initiates the drive wheel locking in the case where the drive source information is information indicating that the drive source (11) is stopped.

2. The controller according to claim 1, wherein
the computer initiates the drive wheel locking on the basis of, in addition to the drive source information, information on a vehicle speed of the straddle-type vehicle (1).

3. The controller according to claim 1, wherein
the computer initiates the drive wheel locking on the basis of, in addition to the drive source information, information on a kickstand (4) of the straddle-type vehicle (1).

4. The controller according to claim 1, wherein
the computer initiates the drive wheel locking on the basis of, in addition to the drive source information, information on a gradient of a road surface.

5. The controller according to claim 1, wherein
the computer varies a braking force generated on the drive wheel (3) in the drive wheel locking on the basis of information on a gradient of a road surface.

6. The controller according to claim 1, wherein
the computer cancels the drive wheel locking on the basis of the drive source information.

7. The controller according to claim 1, wherein
the computer cancels the drive wheel locking on the basis of information on a brake operation by the rider of the straddle-type vehicle (1).

8. The controller according to claim 1, wherein
the computer cancels the drive wheel locking on the basis of information on a kickstand (4) of the straddle-type vehicle (1).

9. The controller according to claim 1, wherein
the drive source information includes information on a switch (14) to start the drive source (11).

10. The controller according to claim 1, wherein
the straddle-type vehicle (1) includes a gear shift mechanism (12) that cannot lock the drive wheel (3) when the drive source (11) is stopped.

11. A control method for controlling a straddle-type vehicle (1), the control method comprising:
acquiring drive source information via a computer, the drive source information being information on a drive source (11) of the straddle-type vehicle (1), and further comprising:
executing drive wheel locking via the computer, in the drive wheel locking, a drive wheel (3) of the straddle-type vehicle (1) is braked and is thereby locked not on the basis of an operation by a rider of the straddle-type vehicle (1), wherein
the computer initiates the drive wheel locking in the case where the drive source information is information indicating that the drive source (11) is stopped.
